(19) United States
(12) Patent Application Publication
(10) Pub. No.: US 2009/0287707 A1
(43) Pub. Date: Nov. 19, 2009

(54) Method to Manage Inventory Using Degree of Separation Metrics

(75) Inventors: Ruthie D. Lyle, Durham, NC (US); Ulysses L. Cannon, Durham, NC (US); Lydia M. Do, Durham, NC (US)

Correspondence Address: Weitzman Law Offices LLC, 425 Eagle Rock Avenue, Suite 102, Roseland, NJ, 07068, US

(73) Assignee: INTERNATIONAL BUSINESS MACHINES CORPORATION, Armonk, NY (US)

(21) Appl. No.: 12/121,762

(22) Filed: May 15, 2008

(51) Int. Cl. G06F 17/30

(52) U.S. Cl. 707/9; 707/E17.009

(57) ABSTRACT

A method for shared management of a virtual avatar's inventory using degrees of separation metrics. The user wishing to share his inventory associates other users with indicia representing the degrees of separation between the user creating the associations and the other users. The user associates the degree of separation indicia with a policy that defines the other users' allowed actions in shared management of the inventory.

### BACKGROUND

1. Field of the Invention

This disclosure relates generally to virtual worlds, and more particularly, to inventories, especially those inventories that contain virtual objects and real data associated with a virtual avatar.

2. Description of Related Art

Avatars serve as virtual representations of users inside virtual worlds. Users create avatars, which are persistent or semi-persistent virtual representations of themselves. The avatars are controlled by the user and interact with the virtual environment and other user avatars in the virtual world.

Users typically have both real and virtual inventories associated with their virtual avatars. Virtual inventories comprise virtual world objects that the virtual avatar may create, acquire or use inside the virtual world. Real inventories include, but are not limited to, real world data and information associated with the avatar, such as 3-d models of avatar body components, object models, animations, sounds, textures, scripts, in game screen shots, and deletions.

In current implementations of real and virtual inventories associated with virtual avatars, users cannot easily share the contents of their real and virtual inventories with other users. Real inventory shared management methods thus far include manual transferring (e.g. by copying onto mobile media), by public hosting on a file server, or by placement in open functional access directories with specific restrictions (e.g., password protection or an allowance list). Contents of virtual inventories are usually transferred in virtual methods. Some examples include in-virtual world graphical trading menus, placement in commonly owned in-virtual world virtual storage accessible by multiple users, or by dropping the virtual item on the ground in the virtual world and instructing another user to pick up the item. Often times shared management of the virtual inventory is simply impossible. A method of enabling more automatic shared management of real and virtual inventory based on user defined logic has not been implemented.

It is desirable to implement a method to enable shared management of both real and virtual inventory using degree of separation metrics. “Shared management” means the ability to see the inventory of another user, access the other user's items, modify or copy the other user's items, and delete or deposit items in the other user's inventory. This enables the leveraging of social network information, more efficient sharing of inventory contents, and generally enhances the cohesiveness of user communities in the context of virtual avatars.

### BRIEF SUMMARY

One aspect of this disclosure relates to a computer implemented method for shared management of a virtual avatar's inventory using degrees of separation metrics. The user wishing to share his inventory associates other users with indicia representing the degrees of separation between the user creating the associations and the other users. The user associates the degree of separation indicia with a policy that defines the other users' allowed actions in shared management of the inventory.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is an exemplary high level diagram of multiple computer systems running both the client-side software and the host virtual world software; and

FIG. 2 is a flow chart illustrating the preferred sequence of steps to enable shared management of a virtual avatar's real inventory and virtual inventory using degrees of separation metrics.

### DETAILED DESCRIPTION

This disclosure is directed to a preferred method of enabling shared management of a virtual avatar's real inventory and virtual inventory using degrees of separation metrics. The preferred method may be implemented as a series of instructions executing on a computer. Such computers executing programs are well known in the art and may be implemented, for example, using a well-known computer processor, memory units, storage devices, computer software, and other components. For example, the shared inventory management method may be a Windows application or part of a Windows application executing on a desktop or laptop computer.

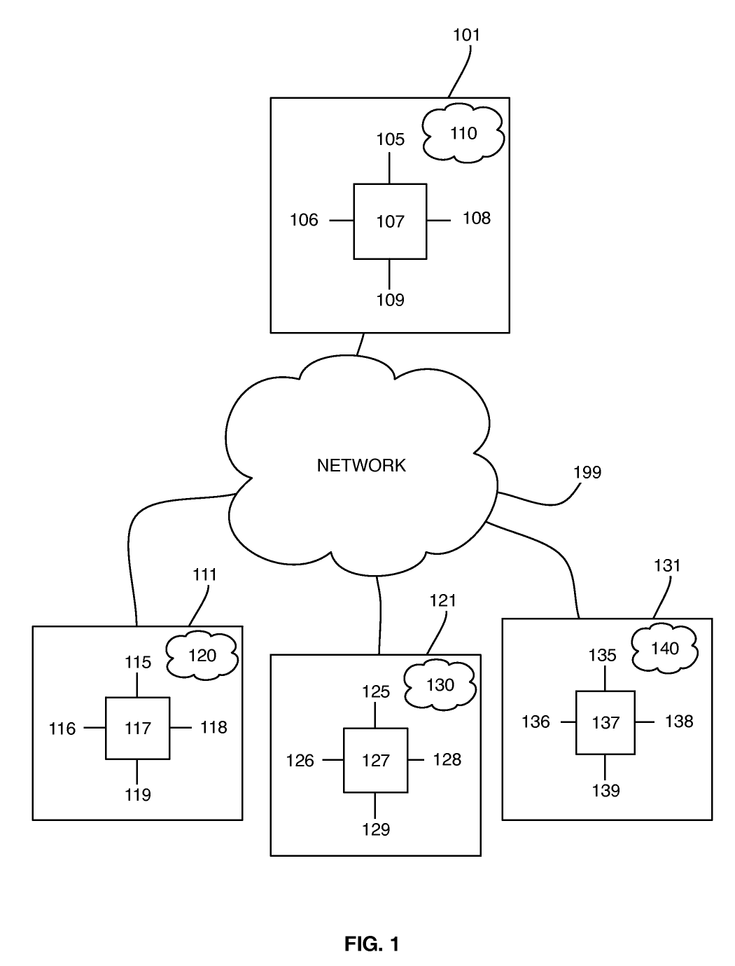

A high-level block diagram of four exemplary computers 101, 111, 121, 131 is shown in FIG. 1. Computer 101 preferably includes a processor 107 that controls the overall operation of computer 101 by executing computer program instructions defining such operation. The computer program instructions may be stored in a storage device 108 (e.g., magnetic disk) or any other computer-readable medium, and loaded into memory 109 when execution of the computer program instructions is desired. Thus, in one embodiment, the shared inventory management method comprises computer program instructions stored in memory 109 and/or storage device 108, and executed by processor 107. Computer 101 also includes one or more network interfaces 105 for communicating with other devices via a network. Computer 101 may also include input/output devices 106, which represent devices allowing for user interaction with computer 101 (e.g., display, keyboard, mouse, speakers, buttons, etc.). Computers 111, 121 and 131 function in substantially the same way. One skilled in the art will recognize that an implementation of an actual computer may contain additional components and that FIG. 1 contains a high level representation of some of the components of such a computer for illustrative purposes.

In accordance with this disclosure, the preferred method enables shared management of a virtual avatar's virtual inventory and real inventory using degrees of separation metrics. A degree of separation is an enumerated closeness value assigned to a social relationship. For instance, User A may utilize a degree of separation metric where numbers are used as the degree indicia. For example, a social value of “1” might be assigned for family members, and a social value of “2” might be assigned to close friends. Other numbering systems based on other types of social relationships are also possible and this disclosure is not intended to be limited to the example mentioned above. The social system used would preferably be chosen by the user.

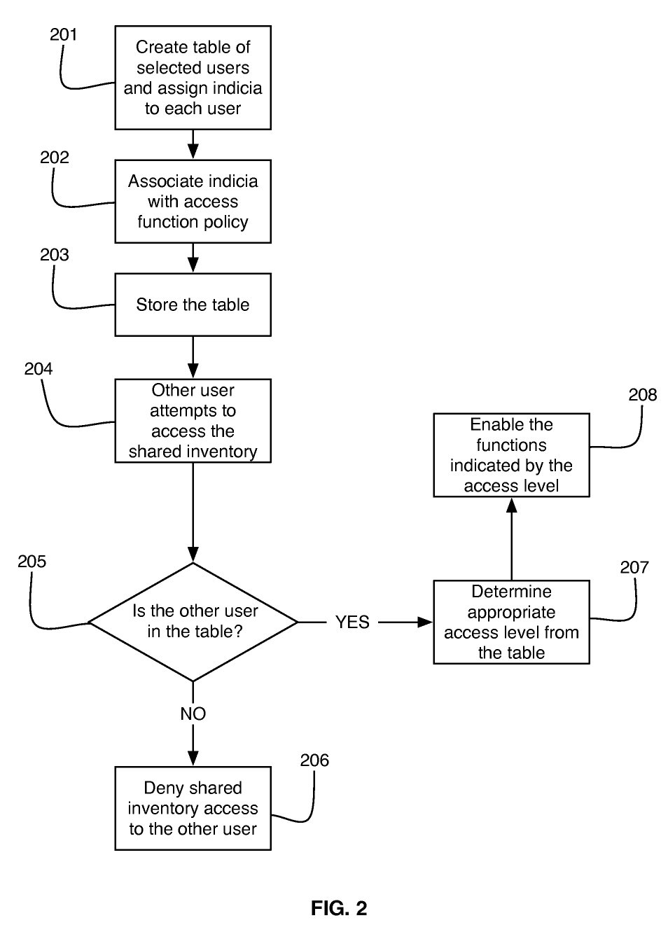

FIG. 2 illustrates a preferred sequence of steps for enabling shared management of virtual inventory and real inventory. User A, who is running virtual world client software 120 on computer 111, wants to enable shared management of User A's virtual avatar. User A's virtual avatar is preferably part of the virtual world created by virtual world host software 110 that is running on server computer 101. Server computer 101 preferably houses both virtual inventory and real inventory associated with all virtual avatars who are part of the virtual world created by host software 110, including User A's virtual avatar.

In step 201, User A may preferably create a user table that associates other users with indicia representing social degrees of separation. The utility that enables users to edit this information would preferably be included in the client software for the virtual world, and include an intuitive graphic user interface. User A may run client software 120 and select the appropriate option from an information menu. The user table editing menu would preferably include fields for the names of other users and their degree of separation. The degree of separation indicia would preferably be limited to numbers. User A types in “B” and “C,” the virtual names for User B and User C, into the name fields. In this example, User A is utilizing the exemplary degree of separation system mentioned above. Assuming, for example, that User B is User A's sibling, User A assigns a value of “1” to User B by typing “1” into the degree of separation field. Because User C is a good friend, User A assigns a value of “2” to User C. A table representing the results is visualized below.

| User | Indicia |
|---|---|
| B | 1 |
| C | 2 |

In step 202, User A may preferably associate the indicia with one or more inventory access functions. In the preferred embodiment, the virtual inventory system should enable all functions normally available on any computer file, including (at the minimum) “read” access (e.g., the ability to “see” inventory contents). The information may be encapsulated in a separate indicia table. User A may, therefore, associate indicia “1” with “read” access and “modify” access (e.g., the ability to “edit” inventory contents), and indicia “2” with “read” access only, by selecting the appropriate options in the graphic user interface. The indicia table created is represented below.

| Indicia | Read Access | Modify Access |
|---|---|---|
| 1 | Yes | Yes |
| 2 | Yes | No |

In step 203, the information may be stored, preferably on the server computer hosting the virtual world. User A may indicate that User A's changes are ready to be implemented to the client software 130 by clicking “OK” in the graphic user interface. Client software 120 then instructs CPU 117 to encapsulate the user table and indicia table into a data packet, and sends it to server computer 101 through network device 115, and subsequently network 199. Server computer 101 receives the data packet through its network interface device 105 and stores it in temporary memory 109. Host software 110 then applies the properties to User A's real and virtual inventory data housed on storage medium 108, and saves the settings on storage medium 108.

In step 204, User B and User C preferably sign on to their virtual world client software instances 130, 140 and attempt to access User A's inventory. In step 205, virtual world host software 110 would attempt to determine whether User B and User C have shared management access User A's inventory, and if so, what functions are available to them. Virtual world host software 110 retrieves User A's user table and indicia table from storage device 108 and places them in temporary memory 109 for computing. Host software 110 then instructs CPU 107 to determine whether User B and User C's virtual names appear in User A's user table. CPU 107 would identify that both names are present.

In step 207, host software 110 would preferably then instruct CPU 107 to determine the indicia associated with User B and User C's virtual names by examining the user table. CPU 107 would identify that User B's indicia is “1” and User C's indicia is “2.” Subsequently, host software 110 would instruct CPU 107 to determine what management actions are associated with each indicia by examining the indicia table. CPU 107 would identify that indicia “1” is associated with both “read” and “modify” access, and that indicia “2” is associated with “read” access only. These results would preferably be combined by host software 110 to determine User B has “read” and “modify” access, while User C has “read” access only.

In step 208, host software 110 would preferably encode a data packet and send it through network device 105 to User B's computer 121 through network 199. Computer 121 would receive the packet through network device 125, and it would be stored in temporary memory 129. Client software 130 may then read the information in the packet, where it would determine that User B is entitled to “read” and “modify” access. Client software 130 would then enable the in-client software option to view (e.g., “read”) and edit (e.g., “modify”) the inventory of User A. User B would then be able to view and edit User A's inventory through a graphical user interface that is preferably part of client software 130.

In step 208, host software 110 would preferably encode a data packet and send it through network device 105 to User C's computer 131 through network 199. Computer 131 would receive the packet through network device 135, and it would be stored in temporary memory 139. Client software 140 may then read the information in the packet, where it would determine that User C is entitled to “read” access only. Client software 140 would then enable the in-client software option to view (but not edit) the inventory of User A. User C would then be able to view User A's inventory preferably through a graphical user interface that is part of client software 140.

In another aspect of this disclosure, the degree of separation indicia may be further altered by special modifiers. For instance, User A may have a strong preference for coffee drinkers over tea drinkers. User A could, therefore, assign a value of “+1” to tea drinkers and a value of “−1” to coffee drinkers. By associating users with their drink preference, User A could alter the final degree of separation. User B is a tea drinker and User C is a coffee drinker. Although User B has an initial degree of separation indicia value of “1,” the tea drinker modifier would add “1” to his score, resulting in an adjusted degree of separation indicia of “2.” Likewise, User C's initial indicia of “2” would be altered by the coffee drinker modifier, subtracting from his score, resulting in an adjusted degree of separation indicia of “1.” Therefore, User C would have “read” and “modify” access, while User B would have “read” access only, completely altering the previous result. This preferred embodiment is not limited to any particular modifier, and may include as many modifiers as desired by a user.

In another embodiment, the method would also include the ability to set a range and depth of inventory functional access. For instance, inventory items may be sortable into user defined categories. The user may, therefore, organize the real and virtual inventories into any configuration desired by the user. This would enable user control of the depth and range of functional access. In other words, the user may enable access to certain inventory functions (e.g., “delete” or “copy”) to only some subset of the total inventory available for shared management by other users. The ability to set range and depth of inventory functional access is not limited by any specific structure of information organization. Any organizational structure, scheme, pattern or plan may be implemented as desired by the user.

Additional embodiments exist. Shared inventory management access may be available while the virtual avatar whose inventory is present in the virtual world, or it may be available only when the virtual avatar whose inventory is being shared is not present in the virtual world. Alternatively, it may be limited to situations where the virtual avatars are interacting in some way, such as chat, trade, or by virtual physical proximity. Naturally, other permutations exist. Users may be allowed to toggle the shared management feature on and off, or the feature may be permanently on. The management activity of other users may be recorded in a log by the user, by the server, or by some other third party. It may not be logged at all. The user may or may not have the ability to update the list of associated users, the associations themselves, modifiers, user names and degree of separation indicia manually while present in the virtual world. Finally, there is no limitation on the possible number of users granted access, the degrees of separation, or the number of modifiers used. The disclosure is not limited to any of the preferred embodiments listed above, and extends to the broadest scope of the claims.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

1. A computer implemented method for shared management of a virtual avatar's inventory in an internet-enabled multiplayer virtual gaming environment, comprising:
associating other users with indicia representing degrees of separation between a user creating the associations and the other users; and
associating the degree of separation indicia with an access policy that defines the other users' allowed actions in shared management of the inventory, the allowed actions including at least viewing the inventory, adding items to the inventory and deleting items from the inventory, wherein the inventory contains at least one in-game virtual object.
